(19) United States
(12) Patent Application Publication
(10) Pub. No.: US 2014/0067407 A1
(43) Pub. Date: Mar. 6, 2014

(54) PERSONAL USER DASHBOARD

(71) Applicants: Vandana SATHE, Saratoga, CA (US); Michael BRAUN-BOGHOS, Munich (DE)

(72) Inventors: Vandana SATHE, Saratoga, CA (US); Michael BRAUN-BOGHOS, Munich (DE)

(73) Assignee: Oracle International Corporation, Redwood Shores, CA (US)

(21) Appl. No.: 13/600,576

(22) Filed: Aug. 31, 2012

(51) Int. Cl. G06Q 50/22

(52) U.S. Cl. 705/2

(57) ABSTRACT

Systems, methods, and other embodiments associated with a personal user dashboard are described. In one embodiment, a method includes extracting, from one or more databases, case processing information about adverse events processed by a group of users. The one or more databases store data about a plurality of adverse events processed by the group of users. The example method may also include calculating metrics using the case processing information. The metrics are performance indicators about processing of the plurality of adverse events by the group of users. The method includes displaying, on a graphical user interface (GUI), user metrics for a user of the group of users. The user metrics are displayed by filtering confidential data from the metrics. The access privileges of the user are limited to a user level access to prevent access to group level data.

### COPYRIGHT NOTICE

A portion of the disclosure of this patent document contains material subject to copyright protection. The copyright owner has no objection to the facsimile reproduction of the patent document or the patent disclosure as it appears in the Patent and Trademark Office patent file or records, but otherwise reserves all copyright rights whatsoever.

### BACKGROUND

Pharmacovigilance is the science of collecting and evaluating information received from healthcare providers (HCP) and patients or consumers about the adverse effects of pharmaceutical and medical products such as biologics, drugs and devices. These medical products can be post-marketed or investigational (i.e., used in clinical trials) depending on the license obtained by their manufacturer for approved human use. An adverse effect/event is any unfavorable or unintended medical occurrence from the use of a medical product. By law, a pharmaceutical manufacturer is required to report such adverse events, within a mandated time period, to a regulatory agency of a country where the manufacturer has obtained a post-market or an investigational license for approved human use. The adverse event assessment, or what is typically called case processing, is performed by, for example, drug/clinical safety operations staff members of a pharmaceutical company or a Contract Research Organization (CRO). By collecting, evaluating and reporting the adverse event information to the relevant regulatory agency about the medical product(s), potential hazards from the medical products can be better identified to prevent future harm to patients.

In order to comply with the regulatory requirements to report the adverse events, operations staff members are required to quickly process the large volumes of adverse events in short time periods. Because of the large volumes and strict time periods, errors and delays may occur in reporting the adverse events to the regulatory agency.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a method associated with displaying personalized metrics for a user.

FIG. 2 illustrates another embodiment of a method associated with displaying personalized metrics for a user about the processing of adverse events.

FIG. 3 illustrates one embodiment of a system associated with displaying personalized metrics for a user.

FIG. 4 illustrates one embodiment of an example screenshot of a user login screen for a personal user dashboard.

FIG. 5 illustrates one embodiment of a screenshot of a graphical user interface associated with a personal user dashboard.

FIG. 6 illustrates one embodiment of a screenshot of a personal user dashboard.

FIG. 7 illustrates one embodiment of a screenshot of a personal user dashboard.

FIG. 8 illustrates one embodiment of screenshot of a personal user dashboard.

FIG. 9 illustrates an embodiment of a computing system in which example systems and methods, and equivalents, may operate.

### DETAILED DESCRIPTION

Systems, methods and other embodiments are described that are associated with a dashboard system that generates a graphical user interface (GUI) for displaying a personal user dashboard to non-managerial users for self-monitoring work progress in relation to departmental goals in real-time, in one embodiment. The dashboard system generates and displays reporting information that is otherwise reserved for department managers and upper management to identify bottleneck areas in workflow and determine overall performance within different departments.

Efficient processing of adverse events or ‘cases’ by operations staff members is important to avoid future harm from defective products and to avoid regulatory penalties for not submitting the adverse event reports in a timely manner. To improve efficiency, the present dashboard system provides a GUI that displays a personal user dashboard that operations staff members can access. The personal user dashboard filters and displays personalized metrics to each of the operations staff members about their performance for processing adverse events. In this way, each operations staff member can individually track and self-monitor their efficiency, compliance, and/or adverse event case load to improve processing of adverse events and avoid delays and errors.

As an example, consider that processing each adverse event in an adverse event processing system can include multiple steps with each step, for example, being assigned to a different staff member based on their education level and medical expertise. Additionally, consider that a manager assigns multiple adverse event cases belonging to one or more medical product(s) to each operations staff for processing through the adverse event processing system. For example, a first staff member may perform data entry for adverse events, a second staff member may code medical terms and drugs in the entry and triage the adverse events, and a third staff member may review and analyze the processed adverse events. Consequently, each step depends on the previous step being completed in the system properly and in a timely manner so that processing can be completed in a timely manner to comply with regulations.

Furthermore, consider that each adverse event is to be completed within a mandated timeframe. Thus, each staff member must complete their processing within a set timeframe so that the adverse events can be processed along the chain of steps without falling out of compliance (e.g., outside of mandated timeframes). This can be a difficult goal to achieve when staff members are assigned many adverse event cases to complete that could belong to one or several medical products. If errors exist from the processing of any individual step, then the adverse event case is sent back to the staff member that generated the error for correction in the adverse event processing system. This could result in processing delays that are undesirable and costly.

Accordingly, systems, methods, and other embodiments generate and display personalized metrics to each staff member so that staff members can maintain an awareness of characteristics about their adverse event processing. In this way, staff members are better prepared to meet departmental goals and comply with processing standards.

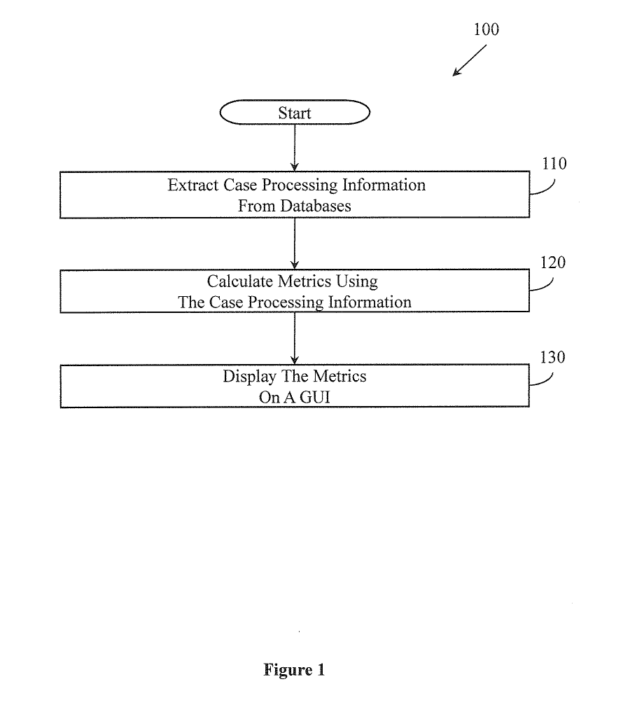

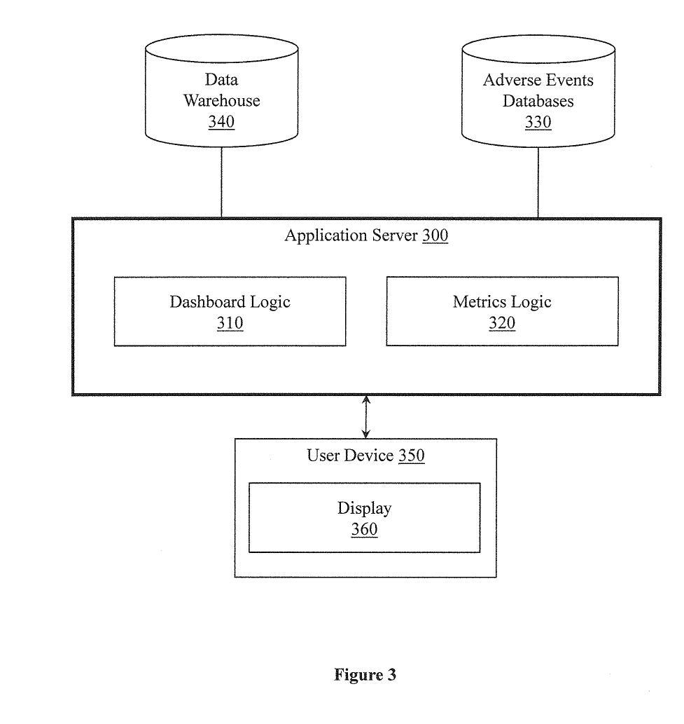

With reference to FIG. 1, one embodiment of a computer implemented method 100 associated with generating and displaying personal metrics on a user dashboard is illustrated. For purposes of this discussion, method 100 will be discussed as being implemented by an application server (e.g., application server 300 of FIG. 3). Before metrics can be displayed to a user on a graphical user interface (GUI) with a personal dashboard, case processing information is gathered by the application server from the adverse event processing system and the metrics are calculated. The adverse event processing system is a computer system that includes many different databases for storing information about the adverse events. The adverse event processing system may be a complex network of computers used by many staff members, departments, and managers to process and monitor adverse events.

At 110 of method 100, the case processing information is extracted by the application server from one or more databases that store information about adverse events. The one or more databases are databases that are part of the adverse event processing system. As previously mentioned, the adverse events are any unfavorable or unintended medical occurrence in a patient that results from the use of a medical drug or product. The information about the adverse events initially comes from reports or data submitted by medical professionals and/or patients, where the information is then logged in the databases. After being logged by staff members using the adverse event processing system, the information is then analyzed by the staff members using the adverse event processing system to identify potential problems with the medical product. Information from this analysis is also stored in the databases to maintain a record for each event that can then be used for additional analysis, for instance, when follow up information is received about the same adverse event, and/or provided to one or more regulatory agencies to comply with reporting duties.

The case processing information, extracted from the databases at 110 by the application server, is administrative information about the processing of the adverse events. The case processing information can include a total number of cases processed by each staff member and/or a group of staff members. The case processing information can also include compliance information such as error rates and processing time for each adverse event. In general, the case processing information is data that is harvested from the records of the adverse events to be used to calculate the metrics at 120.

The metrics are calculated at 120 by the application server. The metrics are performance indicators (e.g., statistics, trends, historical markers, and so on) about the processing of the adverse events. The metrics can be calculated for individual users and/or for a group of users. More generally, the metrics can include a volume of adverse events assigned to a user, a volume of adverse events completed by a user, numbers of adverse events that are in different completion states, error rates of a user, repeat rates for adverse events that a user reprocesses, pending adverse events, and/or contingency adverse events completed on behalf of other users. The metrics can also include trends over time for these numbers, statistical comparisons of these numbers against other users/groups, statistical averages, statistical deviations from a standard, and so on.

In one embodiment, the metrics include productivity metrics and compliance metrics. The productivity metrics quantify an efficiency of the user at processing adverse events (e.g., adverse events processed per unit time). The compliance metrics quantify a deviation in relation to a set of criteria for processing the adverse events by the user (e.g., adverse events processed versus a group average). The metrics may also include exceptions for when the user is sidetracked to process adverse events assigned to a different user. For example, the productivity metrics may include a separate column denoting that processing of adverse events by the user also includes adverse events processed for co-workers.

Additionally, time periods of the metrics can be either historical (e.g., past timeframes), or can include current data. Thus, the metrics can be historical metrics, or current metrics. The current metrics display changes to the case processing information in real-time as they occur. In this way, the metrics can be dynamically updated so that a user can self-monitor their current performance using the personal user dashboard.

Continuing with method 100, at 130, metrics for a user are displayed on a graphical user interface (GUI) (e.g., a personal user dashboard). In one embodiment, the GUI is a webpage that is generated for the user by the application server. The GUI is personalized with metrics specific to a user that has logged on. To personalize the GUI, at 130, the application server filters the metrics based, at least in part, on access privileges of the user. In one embodiment, filtering the metrics involves removing confidential data from the metrics that the user does not have permission to view. The confidential data may be data used by department management and upper management to identify bottleneck steps in processing of the adverse events that includes sensitive information about other users and information that is not directly relevant to processing by the user.

For example, consider that the metrics calculated by the application server include not only personalized metrics for the user, but metrics for each user that processes adverse events for the same product. Because the user is not a manager but only a data entry or other staff member, the application server customizes the personal user dashboard for the user. This is because every user is not permitted to view specifics about metrics of other users, only managers that have group level access can view metrics of other users. Therefore, the user has access to only user level data and not, for example, group level data that includes information about other users. The user level data is data related to processing performed by the user and not data that identifies other users, data associated with groups other than a group of the user, and so on.

In this way, at 130, the application server can display the personalized metrics for a user in juxtaposition to metrics for the group of users without compromising confidential data. Displaying individual metrics along with group metrics that have been filtered of confidential data permits a user to self-monitor their performance against, for example, a group average or other relevant information for determining productivity and compliance of the user. In addition to using the access privileges of the user to personalize the metrics, a job role of the user may also be used when filtering the metrics so that metrics that are only relevant to the user are displayed.

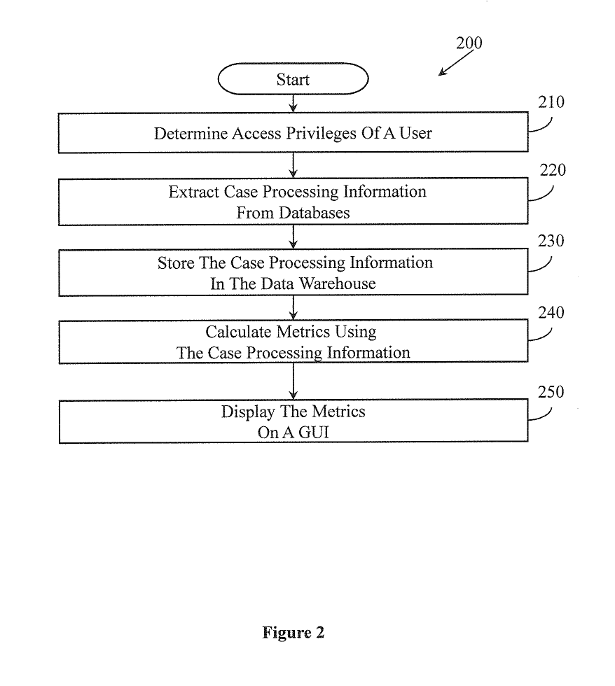

The access privileges and the job role of a user are determined, for example, by the application server from login credentials of the user. FIG. 2 illustrates a computer implemented method 200 that includes, at 210, determining the access privileges of the user by, for example, the application server. In method 200, login credentials of the user are received by the GUI and are used to determine access privileges and/or a job role of the user at 210.

In one embodiment, determining the access privileges of the user includes the application server querying an enterprise security service using the login credentials. The enterprise security service is, for example, a computer system that maintains user policies, access privileges, and other security information for an enterprise. In response to the query, the security service provides a determination of, for example, an access level (e.g., access privileges) and a job role of the user. Using the combination of the access level and the job role, the application server can display appropriate metrics the user, at 250, on the GUI without compromising confidential data that shouldn't be viewed by the user.

At 220, similar to 110 of method 100, the application server extracts case processing information from one or more databases. However, unlike method 100, at 230 of method 200, the application server stores the case processing information in one or more predefined tables of a data warehouse. The data warehouse is one or more databases that include the predefined tables. The predefined tables are database tables that include fields that are formatted into a predefined data format. Accordingly, as part of storing the case processing information into the predefined tables, the application server transforms the data into a format (e.g., extensible markup language (XML)) that is compatible with the fields of the predefined tables.

In addition to storing the data in a predefined format in each table, each table is configured to be accessible to only users of a corresponding access level and job role. Because each of the predefined tables is configured to store only information that is specific to users of a particular access level (e.g., user level) and a particular job role (e.g., data entry, coder, etc.) the application server can control access to different information by simply controlling access to the different predefined tables. In one embodiment, each table includes only information that is permitted to be displayed to a user with a corresponding access level and job role.

For example, consider that a first predefined table includes information accessible to a user with user level access that has a job role of a coder. By contrast, a second table includes information accessible to a user with user level access that has a job role of data entry. A third table includes information that is in both the first and the second table and is accessible to a user with group level access that has a job role of a manager. Accordingly, information in the first and second predefined tables does not include group information, patient names, or other confidential information not accessible to a user without the appropriate access privileges and job role.

At 240, similar to 120 of method 100, the application server calculates the metrics using the case processing information. At 250, confidential information is filtered from the GUI by use of a predefined table that is limited to information accessible with the access privileges of the user. The application server can then display the metrics, at 250, on the GUI for viewing by the user. In this way, metrics for the user and other contextual data can be viewed by a requesting user without compromising confidential data.

Further details of the predefined tables and displaying personalized metrics on the GUI to a user will be discussed with FIG. 3. FIG. 3 illustrates one embodiment of a system that includes an application server 300. The application server 300 is configured to provide a GUI with personalized metrics to a requesting user. In one embodiment, the application server 300 includes a dashboard logic 310 and a metrics logic 320. The metrics logic 320 is configured to calculate metrics to display on the GUI. The metrics logic 320 is also configured to extract case processing information from one or more adverse events databases 330 for use when calculating the metrics. In this way, the metrics logic 320 tracks personalized metrics of the user.

In one embodiment, the metrics logic 320 stores the case processing information in a data warehouse 340. The metrics logic 320 may also store calculated metrics in the data warehouse 340. The data warehouse 340 is a database that includes predefined tables for storing the case processing information and the metrics. The predefined tables are database tables that have been formatted in a way to store the case processing information so that information in each table is information for only users with a certain job role and access privileges. Storing the case processing information, in this way, filters confidential data and prevents users from accessing data that is restricted to users with a higher access level (e.g., user level from accessing group level data). The case processing information stored in the data warehouse 340 is used by the metrics logic 320 to calculate metrics for a requesting user.

The dashboard logic 310 can access the metrics from the data warehouse 340 for display to a requesting user. The dashboard logic 310 is configured to display many different metrics to a user along with other contextual information (e.g., historical averages for similar time periods and so on) from the case processing information in the data warehouse 340. In general, the metrics are performance indicators about processing of adverse events by the user. To maintain awareness of their workflow, a user can self-monitor their progress using the metrics about processing adverse events.

For example, consider that a user device 350 (e.g., a tablet computer) with a display 360 (e.g., a touch screen) can communicate with the application server 300 over a network or other communication channel. While a user is working and processing adverse events during a work shift, the user can provide login credentials to the application server 300 via the user device 350. Upon receiving the login credentials from the user, the dashboard logic 310 is configured to display metrics about adverse events processed by the user, the metrics having being determined on an ongoing basis real-time by the metrics logic 320. In one example, the dashboard logic 310 displays the metrics by providing a web page with the metrics to the user device 350. The dashboard logic 310 can provide the metrics in response to receiving the login credentials of the user and verifying access privileges and a job role of the user. Metrics specific to the user can then be provided by the dashboard logic 310 for display on the display 360 of the user device 350.

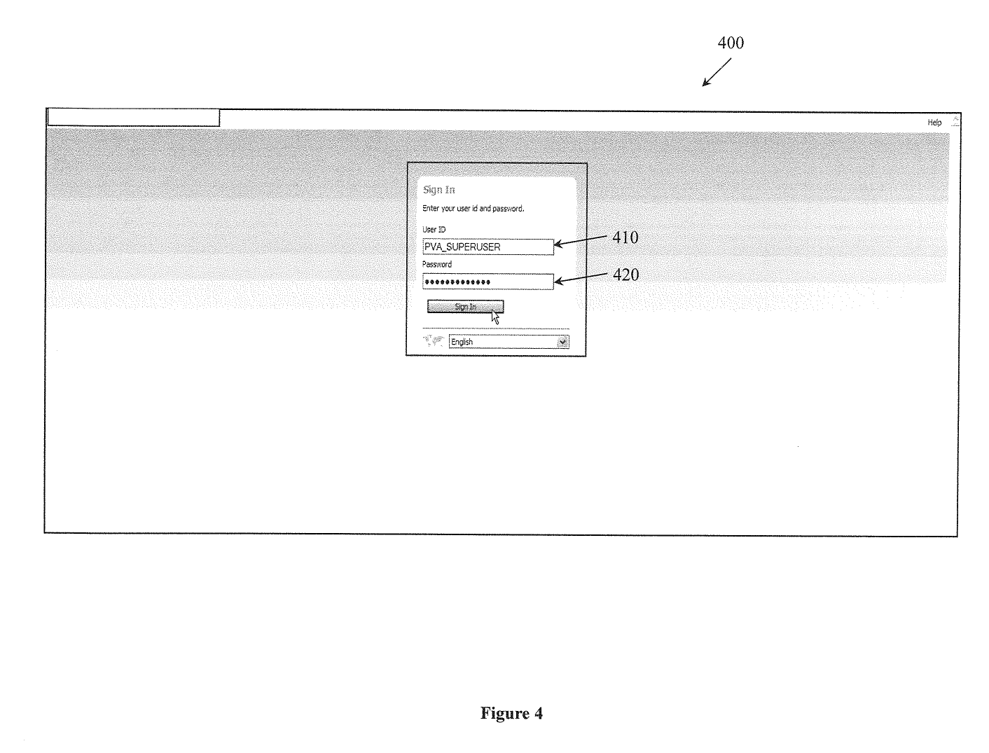

The login credentials sent to the application server 300 are, in one example, provided when the user enters the login credentials on a screen of the GUI. For example, FIG. 4 illustrates one example login screen 400 of the GUI. The login screen 400 is generated by, for example, the application server 300 and displayed remotely on the user device 350. In FIG. 4, the login screen 400 includes two fields, a user ID field 410 and a password field 420. In one embodiment, a user provides a user ID in the user ID field 410 and a password in the password field 420 as credentials to login to the GUI. By logging in through the screen 400, a request is automatically transmitted to the application server 300 for personalized metrics of the user. Accordingly, upon entering credentials in the fields 410 and 420, the user device 350 can transmit the credentials to the application server 300 for verification and use by the application server 300 in generating a personal user dashboard for the user.

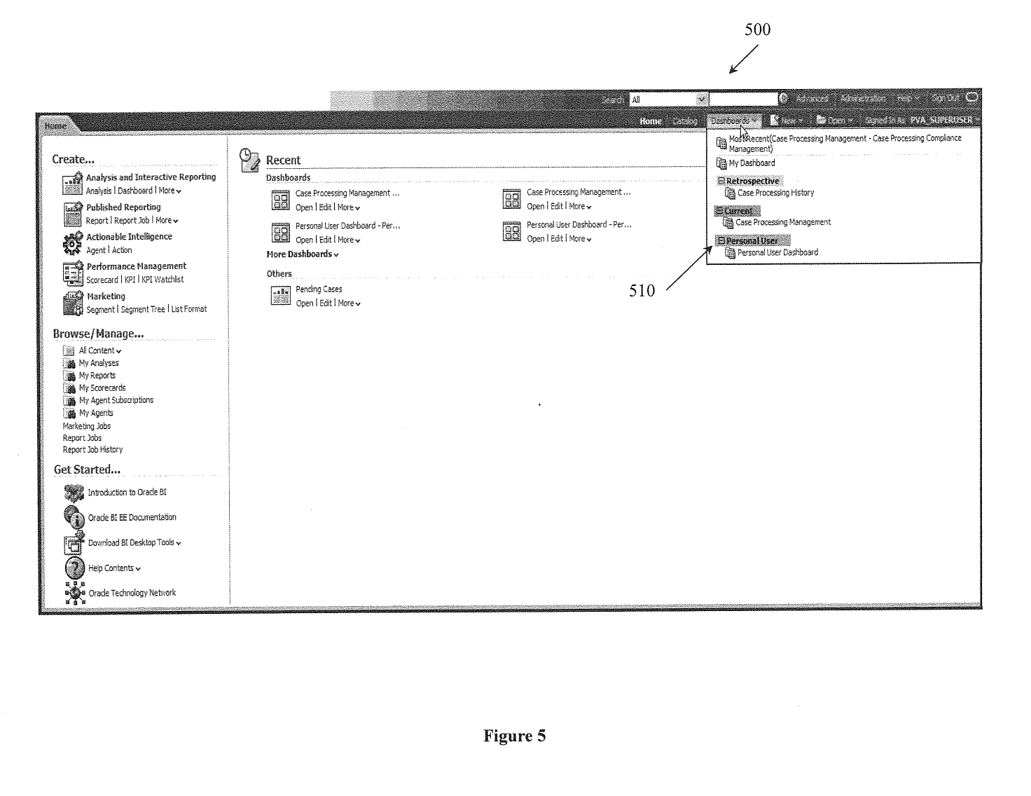

FIG. 5 illustrates an example of a primary screen 500 of the GUI. The primary screen 500 is one example of a first screen that can be displayed upon successfully logging in through the screen 400. The primary screen 500 includes an option for a personal user dashboard 510. By selecting the personal user dashboard 510, the GUI displays the personal user dashboard with personalized metrics for the user. The primary screen 500 can also provide access to the adverse events processing system for the user. Thus, in one embodiment, access to the personal user dashboard and the adverse events processing system is through the GUI.

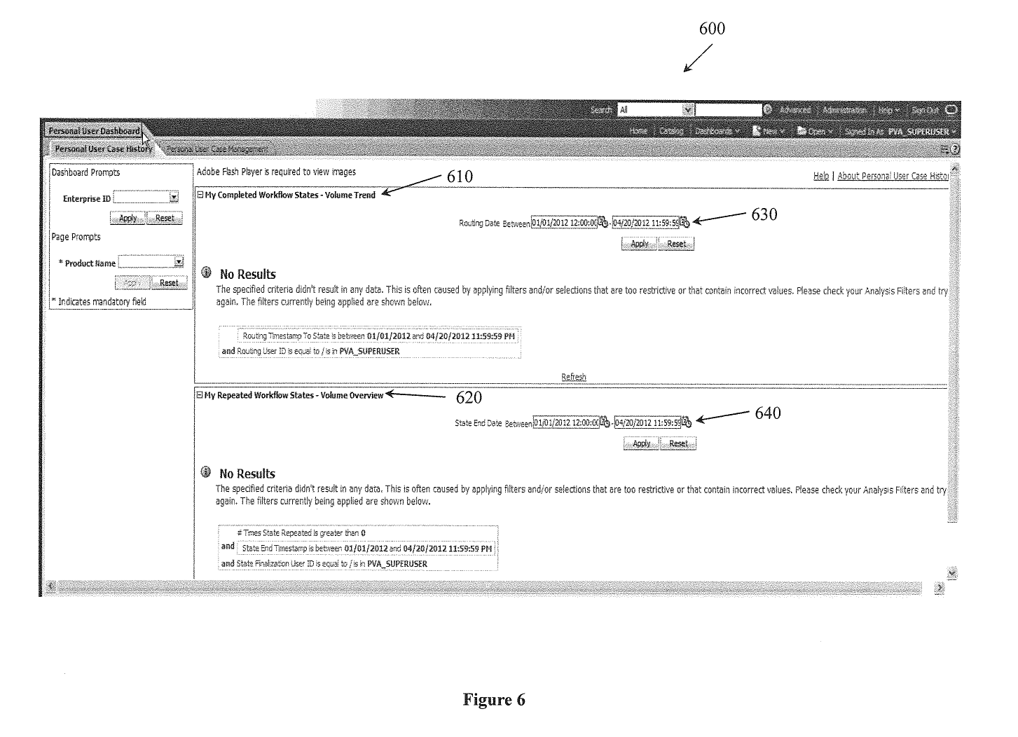

FIG. 6 illustrates one screenshot of a personal user dashboard 600. The personal user dashboard 600 includes a “My Completed Workflow States—Volume Trend” metric 610 and a “My Repeated Workflow States—Volume Overview” metric 620. However, in FIG. 6, the metrics 610 and 620 are not populated with any data. This is because there is no data to display for the user or the date ranges 630 and 640 are not set for a valid date range during which data exists for the user. However, the personal user dashboard screen 600 can include different graphs and charts to illustrate the metrics 610 and 620 to a user when data is available.

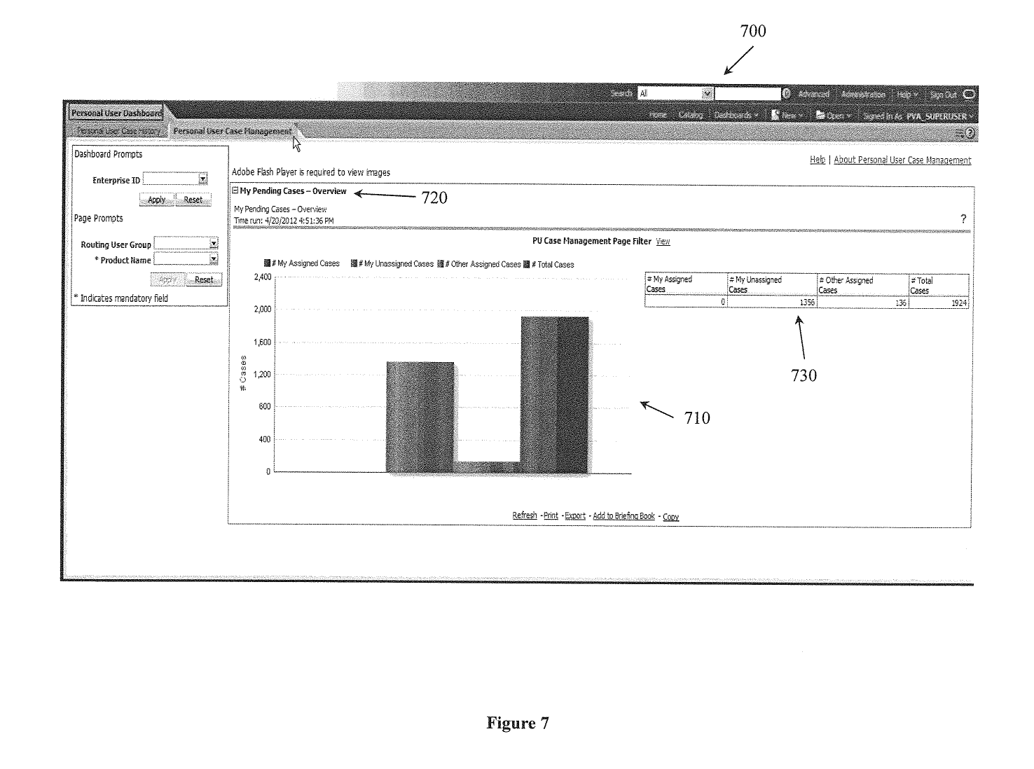

FIG. 7 illustrates one example of a screenshot of a personal user dashboard 700. The personal user dashboard 700 includes a chart 710 that shows metrics for a “My Pending Cases—Overview” metric 720. The chart 710 is a bar graph for four categories 730 of cases (e.g., adverse events) associated with the user. For example, the four categories 730 include a number of assigned cases for the user, a number of unassigned cases for the user, a number of assigned cases for others, and a total number of cases.

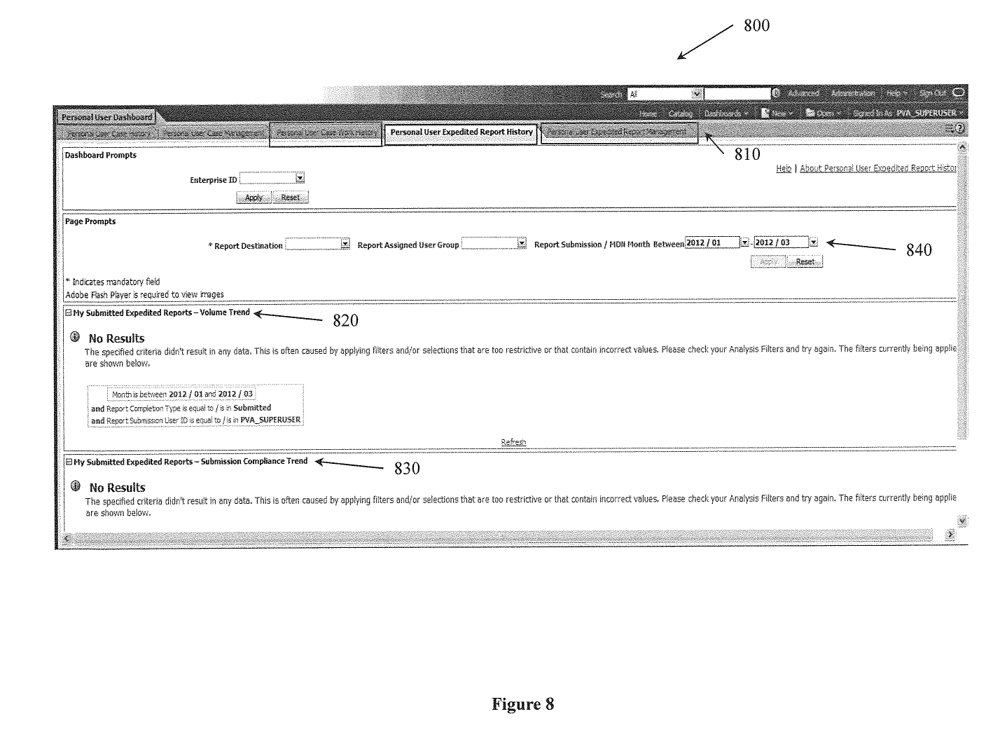

FIG. 8 illustrates another example of a screenshot of a personal user dashboard 800. The personal user dashboard 800 includes a tab-list 810 with tabs for different pages of personalized metrics for the user provided by the personal user dashboard 800. The personal user dashboard 800 also includes a “My Submitted Expedited Reports—Volume Trend” metric 820 and a “My Submitted Expedited Reports—Submission Compliance Trend” metric 830. In FIG. 8, the metrics 820 and 830 do not include any data for a specified time period 840; therefore, no metrics are actually displayed.

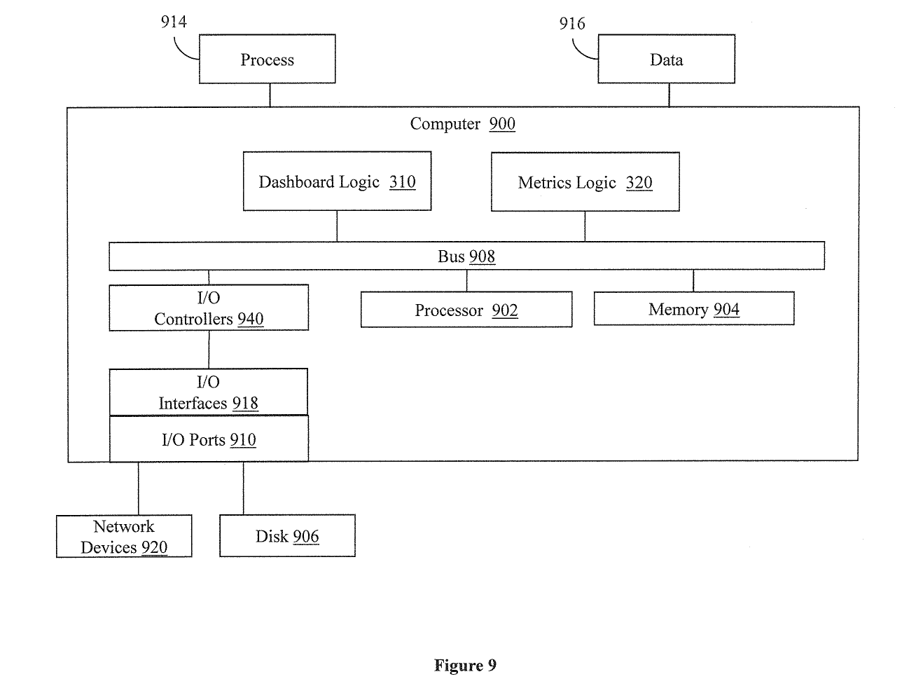

FIG. 9 illustrates an example computing device in which example systems and methods described herein, and equivalents, may operate. The example computing device may be a computer 900 that includes a processor 902, a memory 904, and input/output ports 910 operably connected by a bus 908. In one example, the computer 900 may include a dashboard logic 310 configured to display metrics for a user on a GUI. The computer 900 may also include a metrics logic 320 configured to calculate metrics about adverse events processed by the user. In different examples, the logics 310 and 320 may be implemented in hardware, a non-transitory computer-readable medium with stored instructions, firmware, and/or combinations thereof. While the logics 310 and 320 are illustrated as hardware components attached to the bus 908, it is to be appreciated that in one example, the logics 310 and 320 could be implemented in the processor 902.

Generally describing an example configuration of the computer 900, the processor 902 may be a variety of various processors including a dual microprocessor and other multi-processor architectures. A memory 904 may include volatile memory and/or non-volatile memory. Non-volatile memory may include, for example, ROM, PROM, and so on. Volatile memory may include, for example, RAM, SRAM, DRAM, and so on.

A disk 906 may be operably connected to the computer 900 via, for example, an input/output interface (e.g., card, device) 918 and an input/output port 910. The disk 906 may be, for example, a magnetic disk drive, a solid state disk drive, a floppy disk drive, a tape drive, a Zip drive, a flash memory card, a memory stick, and so on. Furthermore, the disk 906 may be a CD-ROM drive, a CD-R drive, a CD-RW drive, a DVD ROM, and so on. The memory 904 can store a process 914 and/or a data 916, for example. The disk 906 and/or the memory 904 can store an operating system that controls and allocates resources of the computer 900.

The bus 908 may be a single internal bus interconnect architecture and/or other bus or mesh architectures. While a single bus is illustrated, it is to be appreciated that the computer 900 may communicate with various devices, logics, and peripherals using other busses (e.g., PCIE, 1394, USB, Ethernet). The bus 908 can be types including, for example, a memory bus, a memory controller, a peripheral bus, an external bus, a crossbar switch, and/or a local bus.

The computer 900 may interact with input/output devices via the i/o interfaces 918 and the input/output ports 910. Input/output devices may be, for example, a keyboard, a microphone, a pointing and selection device, cameras, video cards, displays, the disk 906, the network devices 920, and so on. The input/output ports 910 may include, for example, serial ports, parallel ports, and USB ports.

The computer 900 can operate in a network environment and thus may be connected to the network devices 920 via the i/o interfaces 918, and/or the i/o ports 910. Through the network devices 920, the computer 900 may interact with a network. Through the network, the computer 900 may be logically connected to remote computers. Networks with which the computer 900 may interact include, but are not limited to, a local area network (LAN), a wide area network (WAN), and other networks.

In another embodiment, the described methods and/or their equivalents may be implemented with computer executable instructions. Thus, in one embodiment, a non-transitory computer-readable medium is configured with stored computer executable instructions that when executed by a machine (e.g., processor, computer, and so on) cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

Definitions

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable medium”, as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

“Logic”, as used herein, includes but is not limited to hardware, firmware, a non-transitory computer readable medium that stores instructions, instructions in execution on a machine, and/or combinations of each to perform a function(s) or an action(s), and/or to cause a function or action from another logic, method, and/or system. Logic may include a microprocessor, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple physical logics.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the disclosure is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is used herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be used.

What is claimed is:

1. A non-transitory computer-readable medium storing computer-executable instructions that when executed by a computer cause the computer to perform a method, the method comprising:
extracting, from one or more databases, case processing information about adverse events processed by a group of users, wherein the one or more databases store data about a plurality of adverse events processed by the group of users;
calculating, using at least a hardware component of the computer, metrics using the case processing information, wherein the metrics are performance indicators about processing of the plurality of adverse events by the group of users; and
displaying, on a graphical user interface (GUI), user metrics for a user of the group of users, wherein the user metrics are displayed by filtering confidential data from the metrics, wherein the confidential data includes case processing information of other users in the group of users, wherein the filtering is based, at least in part, on access privileges and a job role of the user, wherein the access privileges of the user are limited to a user level access to prevent access to group level data.

2. The non-transitory computer-readable medium of claim 1, wherein the plurality of adverse events are adverse events for one or more medical products.

3. The non-transitory computer-readable medium of claim 1, comprising:
determining the access privileges of the user from login credentials received by the GUI, wherein determining the access privileges includes determining whether the access privileges permit user level access or group level access and determining a job role of the user.

4. The non-transitory computer-readable medium of claim 1, comprising:
storing the case processing information in a data warehouse that includes one or more predefined tables, wherein storing the case processing information includes transforming the case processing information into a format that is compatible with the one or more predefined tables, and wherein a table of the one or more predefined tables includes information available to a corresponding access level by restricting access to the table based on access privileges of a user.

5. The non-transitory computer-readable medium of claim 1, wherein displaying the metrics occurs in real-time as the case processing information from the one or more databases changes.

6. The non-transitory computer-readable medium of claim 1, wherein the metrics include productivity metrics that quantify an efficiency of the user at processing adverse events, and compliance metrics that quantify a deviation in relation to a set of criteria for processing the adverse events by the user.

7. The non-transitory computer-readable medium of claim 1, wherein the metrics include exceptions for when the user is sidetracked to process adverse events assigned to a different user.

8. The non-transitory computer-readable medium of claim 1, wherein displaying the metrics includes displaying one or more of, a volume of assigned work, a volume of completed work, metrics for work in different completion states, error rates, repeated work rates, pending work, contingency work completed on behalf of other users, historical metrics, and current metrics.

9. The non-transitory computer-readable medium of claim 1, wherein displaying the metrics on the GUI includes displaying the metrics on a user dashboard displayed on a touch screen of a portable computer.

10. A system, comprising:
metrics logic implemented in a non-transitory computer-readable medium and configured to calculate metrics using case processing information about adverse event cases processed by a group of users, wherein the metrics are performance indicators about processing of the adverse event cases by the group of users; and
dashboard logic configured to display the metrics on a display screen based, at least in part, on access privileges and a job role of a user requesting to view the metrics on a user dashboard, wherein the user dashboard includes a graphical user interface (GUI), and wherein the dashboard logic is configured to display the metrics by filtering information from the metrics that is confidential and not accessible with the access privileges of the user.

11. The system of claim 10, wherein the metrics include productivity metrics and compliance metrics, wherein the productivity metrics quantify an efficiency of the user at processing the adverse event cases, and wherein the compliance metrics quantify a deviation in relation to a set of criteria for processing the adverse event cases by the user.

12. The system of claim 10, wherein the dashboard logic is configured to display the metrics by displaying one or more of, a volume of assigned work, a volume of completed work, metrics for work in different completion states, error rates, repeated work rates, pending work, contingency work completed on behalf of other users, a number of assigned adverse event cases, a number of completed adverse event cases, historical metrics, or current metrics.

13. The system of claim 10, wherein the dashboard logic is configured to display the metrics in one or more charts.

14. The system of claim 10, wherein the dashboard logic is configured to display the metrics on a remote user device.

15. The system of claim 10, wherein the dashboard logic is configured to determine the access privileges of the user from login credentials received by the GUI, wherein the dashboard logic is configured to determine the access privileges by determining whether the access privileges of the user are user level privileges or group level privileges and by determining a job role of the user.

16. A method, comprising:
tracking, using at least a processor, case processing information for adverse event cases processed by a group of users, wherein the case processing information is regulatory data produced by the group of users about the adverse event cases; and
displaying, on a graphical user interface (GUI), metrics for a user of the group of users, wherein the metrics are displayed in response to receiving access privileges of the user, and wherein displaying the metrics includes filtering confidential data from the metrics based, at least in part, on the access privileges and a job role of the user.

17. The method of claim 16, wherein the metrics are performance indicators about processing of the adverse event cases by the user.

18. The method of claim 16, wherein the metrics include productivity metrics and compliance metrics, wherein the productivity metrics quantify an efficiency of the user at processing the adverse event cases, and wherein the compliance metrics quantify a deviation in relation to a set of criteria for processing the adverse event cases by the user.

19. The method of claim 16, wherein the adverse event cases are reported to a pharmaceutical manufacturer for one or more medical products.

20. The method of claim 16, determining the access privileges of the user from login credentials received by the GUI, wherein determining the access privileges includes determining whether the access privileges of the user are user level privileges or group level privileges and determining a job role of the user, and wherein the access privileges of the user are limited to a user level access and prevent access to group level data.
